(19) United States
(12) Patent Application Publication
(10) Pub. No.: US 2007/0018004 A1
(43) Pub. Date: Jan. 25, 2007

(54) Identification mark and a method of reading out information therefrom

(76) Inventor: Boris Aronovich Gurovich, Moscow (RU)

Correspondence Address: WILLIAM COLLARD;COLLARD & ROE, P.C., 1077 NORTHERN BOULEVARD, ROSLYN, NY, 11576, US

(21) Appl. No.: 11/485,568

(22) Filed: Jul. 12, 2006

(30) Foreign Application Priority Data
Jul. 12, 2005 (RU) 2005 121916

(51) Int. Cl. G06K 19/06

(52) U.S. Cl. 235/493; 428/692.1; 428/693.1; 235/449

(57) ABSTRACT

An identification mark is disclosed comprising a substrate on which a plurality of code elements is arranged, each having a different coercive intensity in the external magnetic field of a given direction. Each code element comprises a low-coercivity layer, a nonmagnetic layer and at least a first group of discrete components arranged in a sequential order. Each discrete component is made single-domain from a magnetic material when magnetized in the easy direction, has the same size, shape anisotropy, coercive intensity, amount of magnetic material and arranged at the same distance to the neighboring discrete component from said first group of discrete components. A method of reading out information from an identification mark is also disclosed, said method including the steps of creating the above described identification mark, establishing a plurality of alternate external magnetic fields of a given direction, sequential magnetization reversal of a plurality of code elements by said plurality of alternate external magnetic fields of a given direction, recording each electromagnetic pulse emitted by each code element when the amplitude of each external magnetic field of a given direction levels the coercive intensity value of each code element, and obtaining the information carried by each code element.

### TECHNICAL FIELD

The present invention relates to information media and methods of reading out information therefrom, and is applicable for development of standard data storage and readout means, electromagnetic identification marks, anti-pilferage marks, solenoid-operated locks, security alarm systems.

### BACKGROUND OF THE INVENTION

A coding device for object identification, including plastic cards used for travelling by underground railway is known (JP 06-243302). This prior art device comprises a plate of a non-magnetic material (paper, plastic, nonmagnetic metal, etc.) with the code elements made of a high-coercivity material with a high coercive intensity arranged on or within said plate. When exposed to external magnetic field with an intensity sufficient for magnetization reversal, these code elements emit an electromagnetic pulse as such magnetization reversal occurs. The intensity of said electromagnetic pulse depends on the size of said code element (amount of magnetic material contained therein) and properties of the material it is made from. The code elements have a rectangular shape and are made, for example, from foil with a thickness of 20 to 250 μm and a length of up to 50 mm. The code elements are arranged on the plate (on within the same) such that their longitudinal axes are parallel to each other and perpendicular to the direction in which the coding device is moved relative to a reader.

The disadvantage of the prior art device consists in its low adaptability to manufacture because of the need to use different materials in order to produce the code elements with varying coercive intensity. Moreover, strict compliance with the device (code elements) orientation relative to the reader is required to enable reliable information identification.

An identification device is known comprising a low-coercivity layer and high-coercivity portions sequentially arranged above said layer, followed by semi-coercivity portions (U.S. Pat. No. 4,956,636). Said semi-coercivity portions according to this device comprise the code elements which, as the information is read out, are either subject to demagnetization (information erasure) or magnetization reversal. Said high-coercivity portions are provided to enhance the integrity of information recorded using the code elements, and the low-coercivity layer allows the demagnetization or magnetization reversal process to be simplified as the encoded information is read out.

This prior art device is not easy to manufacture on a commercial scale, either, because of the need to use different materials for producing various layers. Still more serious difficulties emerge when multibit marks are produced, since in this case it is necessary to use and assemble a large number of different materials with different coercive intensity values. These problems render difficult manufacture of such identification devices and considerably increase their cost.

A multi-bit identification mark for storing of digital information, comprising a plurality of magnetic structures is known (U.S. Pat. No. 5,583,803), each of said structures serving as a code element and containing a substrate, said substrate having an active amorphous magnetic layer, a first intermediate nonmagnetic layer, a high-coercivity layer, a second intermediate nonmagnetic layer and a low-coercivity layer sequentially arranged thereon.

As is seen from the description of the magnetic structures, these consist of five different layers, making difficult commercial manufacture thereof and inevitably resulting in a significantly increased product cost.

All magnetic material layers, namely, the active amorphous magnetic layer, the high-coercivity layer and the low-coercivity bypass layer, have macroscopic dimensions and, consequently, a multidomain magnetic structure of each layer. Given such a multidomain structure of the magnetic layers, the magnetization reversal value of each code element may be changed only by changing the magnetic resistance between the low-coercivity bypass layer and the other two magnetic layers, since the coercive intensities of each of the three layers of the same type are the same in any code element. For said reasons, given such structure of the code elements, five layers are inevitably used to produce different code elements of the mutibit identification mark

Moreover, the presence of nonmagnetic spacing between the neighboring code elements is made inevitable by the design and arrangement of different code elements in the mark discussed herein, so that the marks are either to be manufactured individually and composed mechanically of different code elements or complicated techniques are to be applied using dozens of process steps similar to those accomplished to manufacture the microprocessor metallic compounds. The latter makes such marks non-competitive due to manufacturing complexity and, hence, high production cost as compared to the passive chip-based identification marks.

A product identification method using product information characteristics is known (U.S. Pat. No. 6,373,388), wherein a magnetic mark is applied to each product, said mark comprising a predetermined set of spaced apart magnetic elements made of a magnetic material with a high magnetic permeability, said product provided with said mark is caused to move within the operating range of the scanning magnetic field, said scanning magnetic field is caused to interact with said magnetic mark whereby output pulses are generated, said pulses carrying information on the magnetic mark magnetic properties and characteristics of the product bearing said magnetic mark, and the information is read out from said magnetic mark.

Two alternate scanning magnetic fields are used to reverse the magnetic mark magnetization, said magnetic fields having their vectors oriented along mutually orthogonal directions.

The magnetic marks are provided in the form of a linear matrix of magnetically active areas and may comprise two or more linear matrixes arranged in a mutually parallel or mutually orthogonal manner, or any required geometrical shape. The size of an elemental magnetic mark depends on the length of its constituent magnetic elements, spacing between such elements and the number of the required information bits.

Since according to the prior art method the magnetic mark is caused to move relative to the scanning magnetic field, compliance of the magnetic field time domain with the linear dimensions of the magnetically active mark areas and spacing therebetween has to be ensured. In this respect, the active areas and spacing therebetween operate in the same manner as in the elements of an optical bar code (a black line bar and a white spacing between the neighboring bars). It appears from this that apart from the magnetic characteristic variability in the active areas, spacing between the neighboring magnetically active areas may be also used to determine the “identity” of a mark.

Therefore, the identification result for the same magnetic mark may vary depending on the marl orientation relative to the direction of its movement.

Moreover, a predetermined orientation of the magnetic mark relative to the scanning magnetic field vector has to be ensured, since such an orientation of the magnetic mark may occur when its operation is impossible, for example, when the magnetization reversal is directed perpendicular to the scanning magnetic field, since in this case an infinite-amplitude magnetic field is required to reverse the magnetization of the mark.

Low performance in terms of error probability is characteristic of the aforesaid method when magnetization reversal coils are used perpendicular to the direction of the magnetization reversal constant magnetic field, as well as low signal amplitude generated by the magnetic mark upon magnetization reversal.

Furthermore, identification of such marks is only possible at short distances comparable to the spacing between the magnetically active areas.

### SUMMARY OF THE INVENTION

It is the main object of the present invention to increase the distance at which the information may be read out reliably from the identification mark.

It is the second object of the invention to enable information readout regardless the identification mark orientation relative to the external magnetic field direction.

It is the third object of the invention to increase the information capacity of the identification mark.

It is the fourth object of the invention to enable simultaneous information readout from a number of identification marks.

It is the fifth object of the invention to improve the ease of manufacture and reduce the manufacturing cost.

To achieve the aforesaid objects an identification mark is provided, said mark comprising a plurality of code elements, each having a different coercive intensity in the external magnetic field of a given direction and adapted to emit an electromagnetic pulse when the amplitude of said external magnetic field of said given direction acting upon each code element to reverse magnetization thereof levels the coercive intensity value of each code element; and a substrate having a plurality of code elements arranged thereon, each code element including a low-coercivity layer, at least a first group of discrete components with a coercive intensity value exceeding the coercive intensity value of said low-coercivity layer, and a nonmagnetic layer arranged between said low-coercivity layer and said first group of discrete components, each discrete component from said first group of discrete components being made single-domain from a magnetic material when magnetized in the easy direction and magnetically connected to said low-coercivity layer, and also having the same size, shape anisotropy, coercive intensity, amount of magnetic material and arranged at the same distance to the neighboring discrete component.

Since each code element is based on single-domain, when magnetized in the easy direction, discrete components having the same magnetic and geometrical characteristics within a single code element, code elements may be obtained with varying coercive intensity. When subject to magnetization reversal in the external magnetic field these code elements generate short-duration and high-amplitude signals, thereby allowing the distance to be increased at which the information may be readout from the identification mark.

Furthermore, a set of discrete single-domain components used to produce the code elements allows higher magnetization reversal rates to be achieved as compared to the multi-domain elements, which is due to a lesser magnetic behavior spread between various single-domain components in said set (considering similarity of their size and shapes). It contributes to an increase in the intensity of an electromagnetic pulse emitted by the code element upon magnetization reversal thereof by the external field.

Advantageously, a low-coercivity layer is provided on a substrate in each code element.

Also advantageously, a first group of discrete components is provided on a substrate in each code element.

Each discrete component is preferably made from the same source magnetic material, with each discrete component from a first group of discrete components of each code element having the size, shape anisotropy, coercive intensity and amount of magnetic material other than the size, shape anisotropy, coercive intensity and amount of magnetic material of each discrete component from said first group of discrete components of any other code element.

Advantageously, each discrete component from a first group of discrete components of each code element is arranged at the same distance to the neighboring discrete component as the distance at which each discrete component from said first group of discrete components of any other code element is arranged from the neighboring discrete component.

Also, advantageously, each discrete component from a first group of discrete components of each code element is arranged at a distance to the neighboring discrete component other than the distance at which each discrete component from said first group of discrete components of any other code element is arranged from the neighboring discrete component.

Therefore, the structure of code elements described above allows multibit (multidigit or multicode) identification marks to be produced from the same magnetic material by using a set of single-domain discrete components in various code elements such that the following parameters of said discrete components resulting in a change in their coercive intensity are varied: shape anisotropy, size, amount of magnetic material and spacing between said discrete components.

Advantageously, a low-coercivity layer of each code element is made integrally with a low-coercivity layer of any other code element; likewise a nonmagnetic layer of each code element is made integrally with a nonmagnetic layer of any other code element.

Such design of nonmagnetic and low-coercivity layers simplifies and decreases the manufacturing cost of the identification mark.

In particular embodiments of the identification mark each code element preferably comprises a second group of discrete components, each discrete component from said second group having the size, shape anisotropy, coercive intensity, amount of magnetic material, and the distance to the neighboring discrete component similar to the size, shape anisotropy, coercive intensity, amount of magnetic material, and the distance to the neighboring discrete component of each discrete component from the first group, each discrete component from said first and said second groups being arranged such that the easy direction of each discrete component in each group is parallel to said easy direction of each neighboring discrete component and forms an angle of 45 to 90 degrees relative to the easy direction of each discrete component of the other said group.

This configuration of the identification mark enables an increased probability of the information error-free readout such that an electromagnetic pulse with the amplitude sufficient for its recording may be received from a single code element and a mark as a whole at high angles of turn (within the range of 45 to 90 degrees) of the easy directions of the single-domain discrete components relative to the external magnetic field direction. At the same time, the information may be read out regardless the orientation of the identification mark relative to the external magnetic field direction, and simultaneous information readout from a number of identification marks is also made available.

A first group of discrete components of each code element preferably has a total area whose ratio to the area of a low-coercivity layer of said code element is from 0.001 to 0.9.

The identification mark preferably comprises a reference code element whose area exceeds the area of each code element from a plurality of code elements.

A low-coercivity layer of each code element preferably has a thickness of 10 to 500 nm.

Each discrete component from a first group preferably has a thickness of 0.1 to 5.0 relative to the thickness of a low-coercivity layer of said code element.

To achieve the above objects a method is provided of reading out information from an identification mark, said method comprising creation of the identification mark, each mark having a different coercive intensity in the external magnetic field of a given direction and is adapted to emit an electromagnetic pulse when the amplitude of said external magnetic field of said given direction acting upon each code element to reverse magnetization thereof levels the coercive intensity value of each code element; and a substrate having a plurality of code elements arranged thereon, each code element including a low-coercivity layer, at least a first group of discrete components with a coercive intensity value exceeding the coercive intensity value of said low-coercivity layer, and a nonmagnetic layer arranged between said low-coercivity layer and said first group of discrete components, each discrete component from said first group of discrete components being made single-domain from a magnetic material when magnetized in the easy direction and magnetically connected to said low-coercivity layer, and also having the same size, shape anisotropy, coercive intensity, amount of magnetic material and arranged at the same distance to the neighboring discrete component; creation a of plurality of external alternate magnetic fields of a given direction; sequential magnetization reversal of a plurality of code elements using said plurality of external alternate magnetic fields of a given direction; recording of each magnetic pulse emitted by each code element when the amplitude of each external alternate magnetic field of a given direction acting upon each code element to reverse magnetization thereof levels the coercive intensity value of each code element; processing said each electromagnetic pulse and obtaining the information carried by each code element.

The proposed method enables obtaining the output pulses emitted upon magnetization reversal of the code elements by the external alternate magnetic fields at a varying rate of change with time, said pulses having high amplitude and short duration, so that a distance from which the information may be read out from the code elements is increased.

Advantageously, each code element contains a second group of discrete components, each of said discrete components from said second group having the size, shape anisotropy, coercive intensity, amount of magnetic material, and the distance to the neighboring discrete component similar to the size, shape anisotropy, coercive intensity, amount of magnetic material, and the distance to the neighboring discrete component of each discrete component from the first group, each discrete component from said first and said second groups being arranged such that the easy direction of each discrete component in each group is parallel to said easy direction of each neighboring discrete component and forms an angle of 45 to 90 degrees relative to the easy direction of each discrete component of the other group.

Preferably, three sources are used to establish a plurality of the external alternate magnetic fields of a given direction, whereby three external alternate magnetic fields of a given direction are established, the vectors of each said field being mutually orthogonal to each other, said three sources being sequentially arranged along the direction in which the identification mark is moved upon magnetization reversal.

By using three sources of the external magnetic fields it is possible to avoid faulty performance of the marks as information is read out therefrom due to an unfavorable orientation of the code elements relative to the direction of the magnetization reversal field, especially, when code elements are used comprising two groups of discrete components whose easy directions form an angle of 45 to 90°.

Advantageously, three pairs of sources are used to establish a plurality of the external alternate magnetic fields of a given direction, whereby three pairs of external alternate magnetic fields of a given direction are established, the vectors of each said pair being mutually orthogonal to each other, said vectors in each said pair are arranged at an angle of 45 to 90°, and said three sources being sequentially arranged along the direction in which the identification mark is moved upon magnetization reversal.

The use of three sources of the external magnetic field for the magnetization reversal of the code elements enables avoiding faulty performance of the marks as the information is read out therefrom, due to an unfavorable orientation of the code elements relative to the direction of the magnetization reversal field even when the code elements are used comprising a single group of discrete components.

Other objects and advantages of the present invention will become clear from the detailed description of particular embodiments thereof and the accompanying drawings.

### BRIEF DESCRIPTION OF THE DRAWINGS

FIG. 1 schematically shows the identification mark according to the first embodiment of the invention;

FIG. 2 is a plan view of the identification mark shown in FIG. 1;

FIG. 3 illustrates the second embodiment of the identification mark of FIG. 1 according to the invention;

FIG. 4 illustrates the third embodiment of the identification mark of FIG. 1 according to the invention;

FIG. 5 illustrates the fourth embodiment of the identification mark of FIG. 1 according to the invention;

FIG. 6 illustrates the fifth embodiment of the identification mark of FIG. 1 according to the invention;

FIG. 7 schematically shows the first embodiment of the identification mark according to the invention, with two groups of code elements;

FIG. 8 schematically shows the second embodiment of the identification mark of FIG. 7 according to the invention, with two groups of code elements;

FIG. 9 schematically shows the first embodiment of the reader for reading out information from the identification mark;

FIG. 10 schematically shows the second embodiment of a reader for reading information from the identification mark of FIG. 9.

### BEST MODE FOR CARRYING OUT THE INVENTION

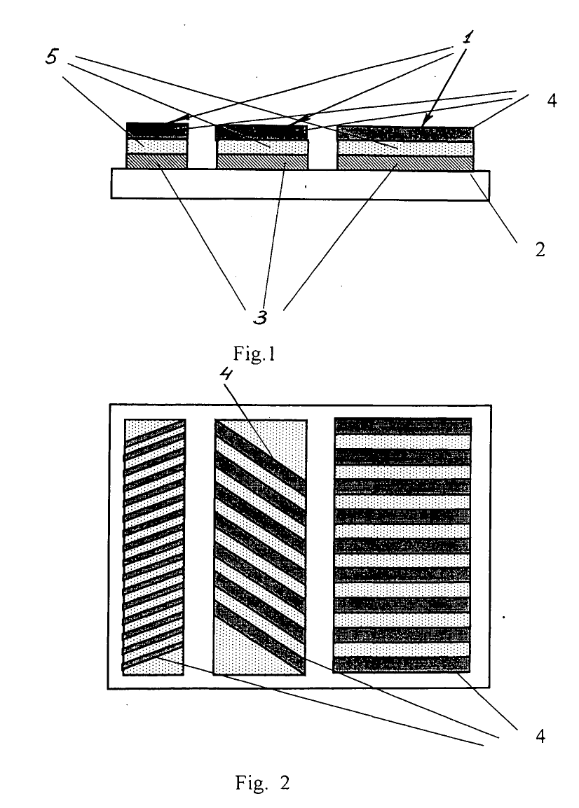

The identification mark according to the present invention comprises a plurality of code elements 1 (FIGS. 1, 2) and a substrate 2 having a plurality of code elements 1 arranged thereon. Each code element 1 comprises a low-coercivity layer 3, at least a first group of discrete components 4 having a value of coercive intensity exceeding the value of coercive intensity of said low-coercivity layer 3, and a nonmagnetic layer 5 arranged between said low-coercivity layer 3 and said group of discrete components 4.

Each discrete component 4 is made single-domain from a magnetic material when magnetized in the easy direction, and is magnetically connected to said low-coercivity layer 3, and also has the same size, shape anisotropy, coercive intensity, amount of magnetic material and is arranged at the same distance to the neighboring discrete component 4.

Each code element 1 of the identification mark has a different coercive intensity in the in the external magnetic field of a given direction and is adapted to emit an electromagnetic pulse when the amplitude of said external magnetic field of said given direction acting upon each code element to reverse magnetization thereof levels the coercive intensity value of each code element.

By the single-domain discrete components 4 those components are meant which are single-domain when magnetized in the easy direction.

Each discrete component 4 is made from the same source magnetic material. Thus, each discrete component 4 of each code element has the size, shape anisotropy, coercive intensity and amount of magnetic material other than the size, shape anisotropy, coercive intensity and amount of magnetic material of each discrete component 4 of any other code element.

As shown in FIG. 2 each discrete component 4 of each code element is arranged at a distance to the neighboring discrete component 4 other than the distance at which each discrete component 4 of any other code element is arranged from the neighboring discrete component 4.

In other embodiments of the identification mark each discrete component 4 of each code element may be arranged at a distance to the neighboring discrete component 4 being the same as the distance at which each discrete component 4 of any other code element is arranged from the neighboring discrete component 4.

The low-coercivity layer 3 stabilizes the single-domain structure along the easy direction of the magnetic discrete components 4 and allows the range of sizes of the discrete components to be widened, wherein varying their size and shape anisotropy results in considerable variations of their typical coercive intensity values.

The nonmagnetic layer 5 is required to avoid direct contact of the single-domain components 4 with the multi-domain low-coercivity layer which may cause the discrete components 4 to lose the single-domain feature and their originally intrinsic properties.

Nanocrystalline cobalt, iron, nickel, alloys, such iron-nickel, iron-cobalt, permalloy and some others may be used as a low-coercivity material.

The sets of single-domain discrete components made from nanocrystalline cobalt, iron, nickel, alloys, such iron-nickel, iron-cobalt, permalloy and some others may be used as a magnetic material with a coercive intensity exceeding that of said low-coercivity material.

However, while the same materials used to produce the discrete components and the low-coercivity material have been recited herein, every time a technique has to be applied enabling that the material of said discrete components has the coercive intensity exceeding that of the material of said low-coercivity layer material.

Nonmagnetic plates or films may be used as a substrate material, for example, silicon, lavsan, polyimide, paper and some others, and silicon oxide, cobalt oxide and other materials may be used as a nonmagnetic material.

By producing the code elements 4 having different coercive intensity from the same magnetic material using the grouped together single-domain discrete components 4 being similar (for each code element) in terms of their shape, size and spacing therebetween, it is possible to create the multibit (multidigit or multicode) identification marks from the same magnetic material by using the sets of single-domain discrete components 4 in various code elements 1 such that in the process of manufacture thereof following parameters are varied leading to a change in their coercive intensity: shape anisotropy, size of discrete components 4, amount of magnetic material and spacing therebetween.

Furthermore, if selective atom removal—accelerated particle flux irradiation method disclosed in RU 2129320, RU 2169398, RU 2227938, RU 2243 613 is used to form the discrete components 4, all other conditions being equal, a change in the irradiation dose also allows their coercive intensity to be changed and values thereof to be obtained significantly exceeding the coercive intensity values of the same material produced by spraying in the process of manufacture of the low-coercivity layer, whereby the information capacity of the produced marks is increased.

As experimentally found by the inventor, unlikely the previously used multi-domain discrete components, the single-domain discrete components have a coercive intensity substantially depending on the shape anisotropy and size and, as a rule, significantly exceeding the coercive intensity of the low-coercivity underlayer made from the same material. This in turn allows a plurality of marks to be produced from the same material, each mark comprising its own unique combination of code elements. In this case, if a binary coding system is used, the muldigit (multibit) marks comprising 64 or 96 code elements are known to allow 2⁶³ and 2⁹⁵ unique marks to be produced, respectively.

Moreover, by using a set of single-domain discrete components to form the code elements it is possible to achieve higher magnetization reversal rates as compared to the multi-domain code elements due to a lesser magnetic behavior spread between various discrete single-domain components in said set (considering similarity of their size and shapes). It has been found that this contributes to an increase in the intensity of an electromagnetic pulse emitted by the code element upon magnetization reversal thereof by the external field.

Supposing that a code element is formed only by a set of discrete single-domain components, only a part of its surface area is filled with the magnetic material. Therefore, the entire surface area of such code element cannot be used to ensure a maximum intensity of the electromagnetic pulse emitted by said code element upon magnetization reversal of its discrete components by the external field.

The surface area of code element may be used to the full if a low-coercivity layer (a layer with a far lower coercivity that that of the single-domain components) is placed over (or under) the layer comprising the discrete components. In this case, given an optimally fitted ratio between the thickness of the discrete components and the thickness of the low-coercivity layer, as well as the spacing between the discrete components being selected so as to ensure their magnetic interaction, it is possible to achieve such an effect that the entire low-coercivity layer material within the code element will be subject to magnetization reversal only simultaneously with the set of discrete components from which it is made up.

Therefore, two results being important in practical terms are achieved. First, the code element has a coercive intensity value intermediate between the low-coercivity layer coercive intensity and the coercive intensity of the discrete components with higher coercivity forming the code element. This coercive intensity is the higher the more is the value of the coercive intensity of the discrete magnetic components.

Moreover, various code elements having a common low-coercivity layer behave independently upon magnetization reversal by the external magnetic field so that the proposed invention may be used to manufacture the multibit electromagnetic identification marks.

Second, where simultaneous magnetization reversal of the low-coercivity layer and the discrete magnetic components is accomplished, a significant increase in the intensity of a signal emitted by the code element is observed, approximately 100 to 200 time as compared to the signal emitted by the same discrete magnetic components upon magnetization reversal in the absence of the low-coercivity layer.

However, direct contact of the discrete components with the layer of a multi-domain low-coercivity material may cause the discrete components to lose the single-domain feature and their originally intrinsic properties. To avoid this, a thin nonmagnetic layer material layer is advantageously used to separate said magnetic material layers.

Therefore, it has been experimentally shown that the presence of two magnetic layers allows the amplitude to be increased of the signal emitted upon magnetization reversal of this “sandwich” (100 to 200 times as compared to a similar single-layer code element having no low-coercivity layer due to the “magnetic intensification” effect). The latter in turn results in an increase in the effective distance at which such multi-layer marks can be readout.

The low-coercivity layer of a multi-layer system is actuated at the amplitudes being the higher, the higher is the coercive intensity of the discrete components arranged thereon. A number of reasons are responsible for the “magnetic intensification” effect: intensification of the magnetic interaction between the single-domain discrete components via low-coercivity layer; acceleration of the low-coercivity layer magnetization reversal, since the magnetization reversal rate will be determined by the magnetization reversal rate of the set of single-domain discrete components; large amount of magnetic material contained in such code elements.

Various embodiments of separate components of the identification device may be provided, as well as various orders of arrangement of the same relative to each other.

One of the possible embodiments of the identification mark has been described with reference to FIGS. 1, 2.

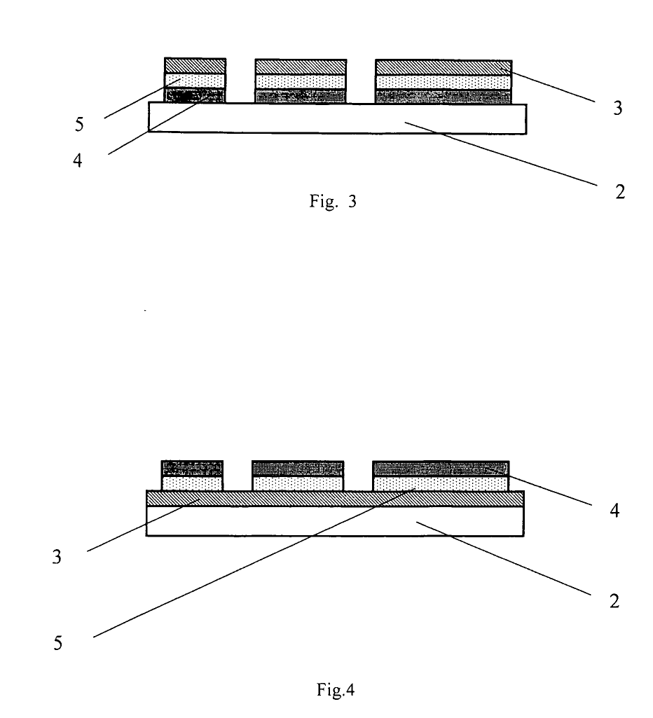

According to another embodiment (FIG. 3) the discrete components 4 are arranged on the substrate 1, the nonmagnetic layer 5 portions are placed on top of said discrete components 4, said portions covering each dedicated (i.e. forming a part of one code element) group of discrete components 4, and the low-coercivity layer 3 portions are arranged on top of the nonmagnetic layer 5.

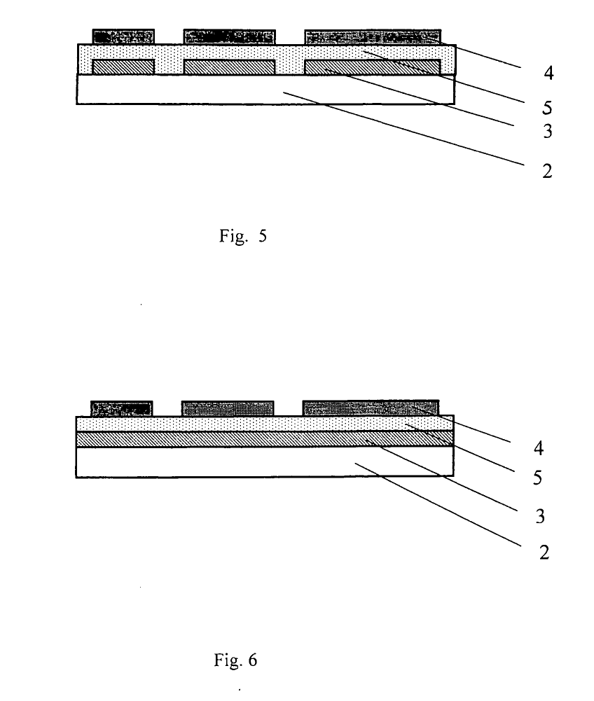

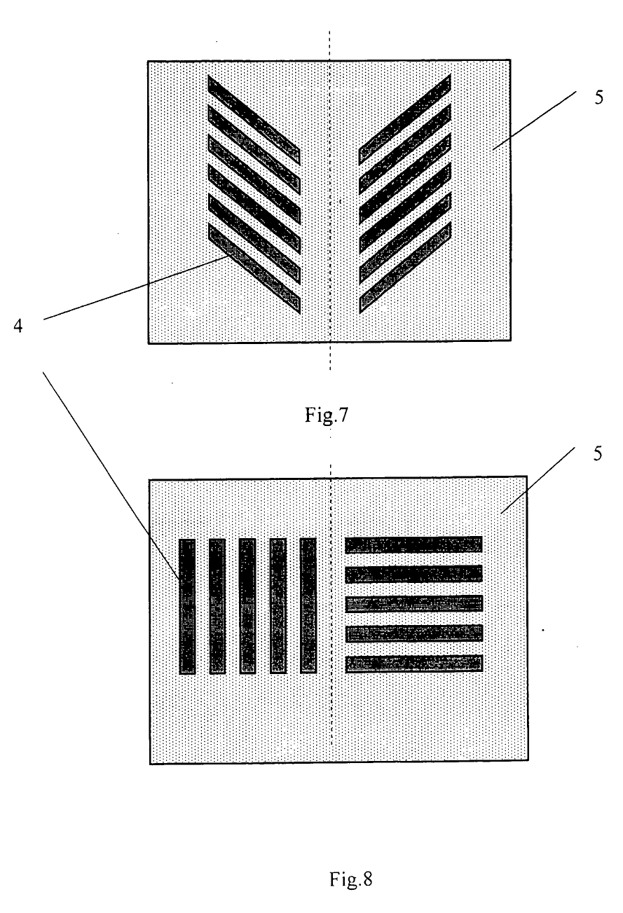

For the ease of fabrication, in some embodiments (FIGS. 5, 6) the nonmagnetic layer 5 is advantageously made continuous, for example, by magnetron deposition. In this case the low-coercivity layer 3 portions will be covered with the nonmagnetic layer 5 so that the sets of single-domain discrete components 4 may be applied to the portions thereof under which the low-coercivity layer 3 portion lies.

Alternatively (FIG. 4), for the ease of fabrication it is advantageous to make the low-coercivity layer 3 continuous and to apply the nonmagnetic layer 5 portions on top of said layer 3 with the discrete components 4 arranged on said nonmagnetic layer 5 portions.

The most preferable embodiment in terms of manufacturing technique of the identification device is the one (FIG. 6) wherein the substrate 1 has the continuous low-coercivity layer 3 applied thereto, the nonmagnetic layer 4 is provided on top of said continuous low-coercivity layer 3, and then the single-domain discrete components 4 are formed in said layer 4 using selective atom removal—mask plate irradiation method while the nonmagnetic layer 5 is preserved between said components and said low-coercivity layer.

In another embodiment of the identification mark (not shown in the drawings) the single-domain discrete components are applied to a substrate, said components are covered with a continuous nonmagnetic layer, and only thereafter a continuous low-coercivity layer is applied to said nonmagnetic layer.

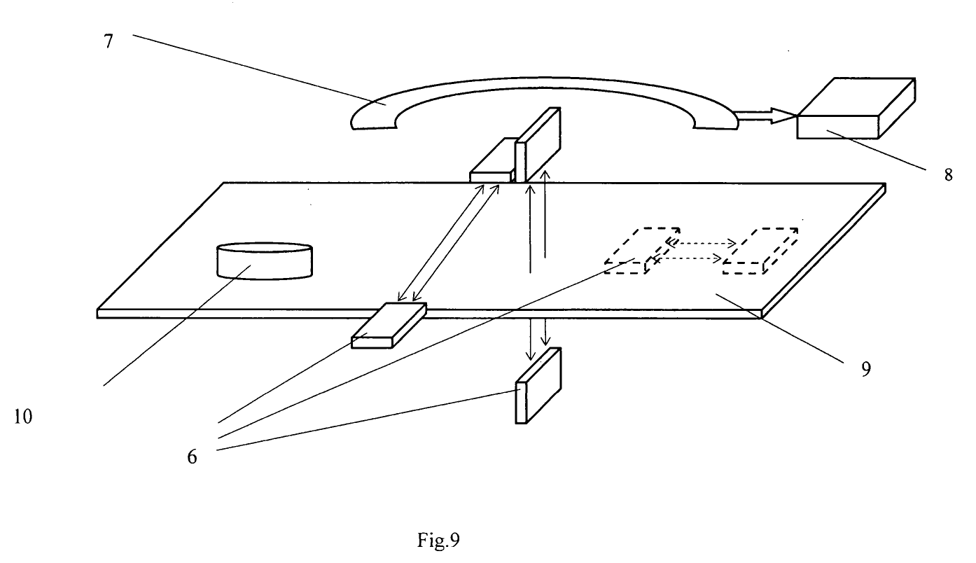

By providing each code element made from the two groups of similar discrete components 4 (FIG. 7, 8) whose easy directions are arranged at an angle of 45 to 90 degrees it is possible to increase the probability of the information error-free readout such that an electromagnetic pulse with the amplitude sufficient for its recording may be obtained from the single code element 1 and the mark as a whole at high angles of turn (within the range of 45 to 90 degrees) of the easy directions of the single-domain discrete components 4 relative to the external magnetic field direction.

By providing the low-coercivity layer 3 whose thickness is of 10 to 500 nm it is possible to increase the electromagnetic pulse emerging upon magnetization reversal of the discrete components 4 by the external field. Where the low-coercivity layer 3 has a thickness less than 10 nm, no intensification of the electromagnetic pulse emerging upon magnetization reversal of the discrete components 4 by the external field is essentially observed. In contrast, it is unpractical to have the layer thickness in excess of 500 nm, since it results in a considerably decreased action of the single-domain discrete components 4 on the coercive intensity of the code elements 1 with essentially no action thereof on the low-coercivity layers 3 which are more distant therefrom.

By providing the single-domain discrete components 4 made from a magnetic material with a thickness of 0.1 to 5.0 relative to the thickness of the low-coercivity layer 3 it is possible to ensure an effective action thereof on the coercive intensity of the code elements 1 and sufficient intensification of an electromagnetic pulse accompanying the magnetization reversal of the discrete components 4. In case this ratio is less than 0.1, the code element 1 coercive intensity will not differ from that of the low-coercivity layer 3 contained therein. If said ratio is in excess of 5.0, then, as experimentally found, essentially no intensification of an electromagnetic pulse accompanying the magnetization reversal of the code elements 1 is observed.

In particular embodiments of the invention, the identification mark is advantageously manufactured in such a way that the ratio between the total area of the set of discrete components in the code element and the area of the low-coercivity layer arranged thereunder is from 0.001 to 0.9.

The ratio between the area of the set of discrete components 4 and the area of the low-coercivity layer 3 is selected within the range from 0.001 to 0.9 because the action of the single-domain discrete components 4 on the low-coercivity layer 3 cannot cover the entire area of said layer where the values are below 0.001. It results in a considerably decreased intensity of the electromagnetic pulse emitted by the discrete components 4 upon magnetization reversal thereof, as well as an additional pulse being emitted by the low-coercivity layer. Where the ratio is above 0.9, it is technically difficult to obtain a set of single-domain discrete components 4, since the spacing therebetween becomes too tight so that a non-controllable mesh of separate discrete components 4 may occur along with an inadmissible change in the magnetic properties of the respective code element 1.

More complicated coding systems of the multibit marks may be also used apart from the binary coding systems, for example, ternary, decimal and the like. Where such coding systems are used, each code element is produced to have one of the three (or ten) discrete values of its area. Accordingly, each value of the code element area, even when these have the same coercive intensity, has a representative value of the signal amplitude emitted by such element upon magnetization reversal, since, all other conditions being equal, the amplitude of the emitted signal is proportional to the amount of magnetic material contained in the code element.

To improve the reliability of the identification mark operation the mark provided with a reference code element with the maximum signal amplitude emitted upon magnetization reversal, with the signal intensity dependent on the area of said reference code element which exceeds the area of each code element from the plurality of code elements (not shown in the drawings).

The method of reading out information from a identification mark according to the present invention comprises the following steps.

An identification mark is created, said mark comprising a plurality of code elements according to one of the embodiments described herein.

Then, a plurality of external alternate magnetic fields of a given direction is created, magnetization of said plurality of code elements is sequentially reversed by said plurality of external magnetic fields, and each electromagnetic pulse emitted by each code element is recorded when the amplitude of said external alternate magnetic fields of a given direction levels the coercive intensity value of each said code element, and each said electromagnetic pulse is processed to obtain the information carried by each said code element.

The device shown in FIG. 9 may be used to implement the method of reading out information according to the invention.

Said device comprises a source of magnetic field, a Helmholtz coil in the particular embodiment, generating a plurality of external alternate magnetic fields of a given direction, each of said fields having a different rate of change with time. Low- or high-frequency alternative current f is applied to the coil 6.

Three sources 6 of magnetic field are advantageously provided to ensure the reliable identification mark operation, said source generating the magnetic fields whose vectors are oriented along three mutually perpendicular directions as shown in FIG. 9. The device also has a reception antenna 7 connected to a signal processing unit 8.

A quadratic component of the magnetization reversal current having a frequency 2f is used to detect and identify the marks. A low-frequency filter is used for signal suppression at the frequency f, said filter forming a part of said signal processing unit 8 also comprising an analog-to-digital converter and a digital signal processor. The signal processing technique and the means used to perform such processing are well-known and not described herein in detail as not relevant to the essence of the invention.

The proposed method is implemented using the above described device in the following manner. An object 10 provided with an identification mark is caused to move along a conveying means 9 via a data reading means where said object 10 is subject to a low-frequency or a high-frequency field generated by a Helmholtz coil. Magnetization of the code elements is sequentially reversed by the action of said magnetic fields as their coercive intensity increases. Said magnetization reversal will last at the frequency 2f until said code elements are remain within the effective range of the alternative current with sufficient amplitude.

The signal processing unit 8 is adapted to detect the code contained in the identification mark, which code is used to give an instruction to ignore, freeze or evaluate the object 10 or a delay instruction.

To avoid problems which may arise upon partial magnetization reversal of the code elements in the identification mark when said mark is found within the areas of insufficient magnetic field amplitude, each mark is provided with a reference code element having the coercive intensity and amplitude of the emitted signal being the maximum among all code elements. The processor is adapted to ignore automatically those signal sequences which contain no signal from such reference code element.

By using three sources of the external magnetic fields it is possible to avoid faulty performance of the marks as information is read out therefrom due to an unfavorable orientation of the code elements relative to the direction of the magnetization reversal field, especially, when code elements are used comprising two groups of discrete components whose easy directions form an angle of 45 to 90°.

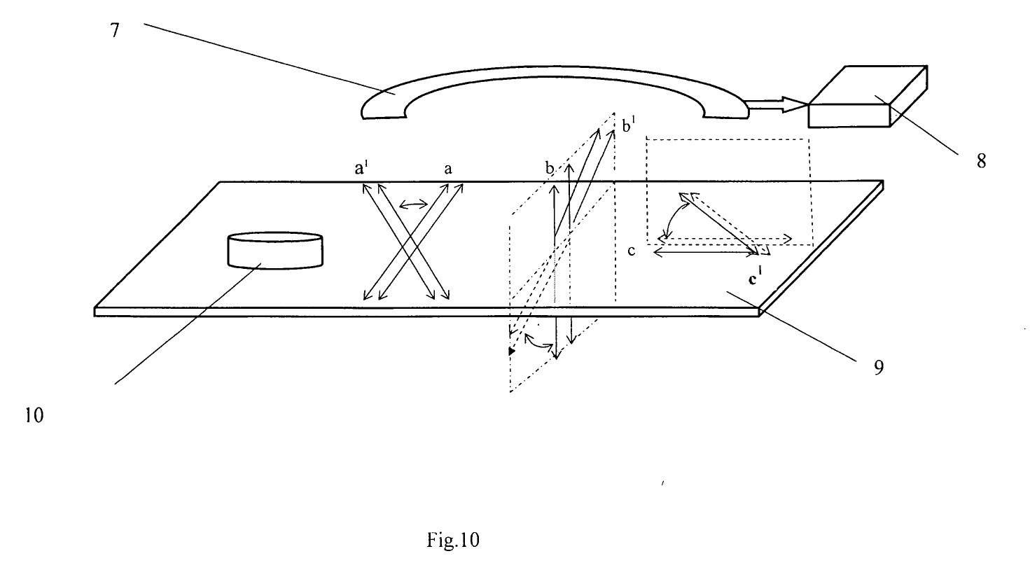

In another embodiment of the method according to the invention a device is provided as described above (FIG. 10). It differs in that three pairs of magnetic field sources 6 are provided whose vectors are arranged by pairs in the mutually orthogonal planes. For the sake of simplicity, the magnetic field sources 6 are shown as double-headed arrows extending in the directions of the vectors of the fields they generate. Letters “a”, “b”, “c” are used to indicate the arrows showing the external magnetic field sources 6 whose vectors extend in the mutually orthogonal directions as shown in FIG. 9. In this case, three more sources referred to as “a¹”, “b¹” and “c¹” are added to the existing external magnetic field sources 6 so that three pairs are formed, each extending in the respective plane with all planes being mutually orthogonal to each other. In this case, the magnetic fields in each pair are directed at an angle of 45 to 90°.

Thus, for example, vectors “a” and “a¹” extend in the plane of the conveying means 9 and are arranged at an angle relative to each other. Vectors “b” and “b¹” extend in the plane perpendicular to the conveying means and the direction of movement of the identification mark, and vectors “c” and “c¹” extend in the plane perpendicular to the conveying means but parallel to the direction of movement of the identification mark.

By using three pairs of external magnetic field sources for magnetization reversal of the code elements it is possible to avoid faulty performance of the identification marks as information is read out therefrom due to an unfavorable orientation of the code elements relative to the direction of the magnetization reversal field even when the code elements are used comprising a single group of discrete components. In this case, simultaneous information readout is ensured from a number of identification marks, for example, where a number of objects (commodity items) are placed in the same shopping basket within the alternate magnetic field effective range.

The present invention is further explained by way of particular examples given below.

### EXAMPLE 1

An identification mark comprising a silicon substrate with a thickness of 0.45 mm and an area of 2 cm² was produced. A low-coercivity layer made from nanocrystalline cobalt with a thickness of 100 nm and an area of 2 cm² was applied to said substrate. A nonmagnetic layer made from cobalt oxide with a thickness of 50 nm was placed on top of said low-coercivity layer, with a group of single-domain discrete components made from nanocrystalline cobalt with a thickness of 30 nm arranged on said nonmagnetic layer. The coercive intensity value of the code elements varied from 25 to 75 Oe, since a set of single-domain discrete components in each code element had a combination of size, shape anisotropy and easy direction characteristic only of this particular code element.

The discrete components in various code elements had a minimum size varying from 5 to 30 μm, a maximum size of 5 to 60 μm, and shape anisotropy of 1 to 6. Thus, for example, the discrete components with a width of 5 μm had a length of 30 μm.

Said identification mark was placed between two strips of paper which in turn were placed in an alternate magnetic field generated by a source of external magnetic field. The distance from the identification mark to said magnetic field source was up to 15 cm. The alternate magnetic field with the frequency of 50 Hz was used to act on the mark. The amplitude of the magnetization reversal field varied from 60 to 240 Oe in the course of the information readout. Signals with the amplitude sufficient for a reliable operation of an analog-to-digital converter were recorded by a recording device situated at up to 5 cm from the identification mark.

### EXAMPLE 2

An identification mark comprising a polyimide substrate with a thickness of 100 μm and an area of 3 cm² was produced. A low-coercivity layer made from a nanocrystalline iron-cobalt alloy with a thickness of 100 nm and an area of 3 cm² was applied to said substrate. A nonmagnetic layer made from silicon oxide with a thickness of 10 nm was placed on top of said low-coercivity layer, with a layer comprising a set of single-domain discrete components made from nanocrystalline cobalt with a thickness of 40 nm arranged on said nonmagnetic layer. The coercive intensity value of the code elements varied from 30 to 50 Oe.

The discrete components had a minimum size varying from 5 to 50 μM, a maximum size of 5 to 60 μm, and shape anisotropy of 1 to 5. Thus, for example, the discrete components with a width of 5 μm had a length of up to 25 μm.

The identification mark was placed inside a plastic case which in turn was placed in a plurality of alternate magnetic fields generated by three sources of external magnetic field with mutually orthogonal magnetic field directions. The distance from the identification mark to said magnetic field source was up to 10 cm. The alternate magnetic field with the amplitude of 60 to 150 Oe was used to act on the mark. The frequency of the magnetization reversal field varied from 50 to 218 Hz in the course of the information readout. Signals with the amplitude sufficient for a reliable operation of an analog-to-digital converter were recorded by a recording device situated at up to 10 cm from the identification mark.

### EXAMPLE 3

An identification mark comprising a lavsan substrate with a thickness of 30 μm and an area of 3 cm was produced. A low-coercivity layer made from nanocrystalline cobalt with a thickness of 25 nm and an area of 3 cm² was applied to said substrate. A nonmagnetic layer made from silicon oxide with a thickness of 7 nm was placed on top of said low-coercivity layer, with a layer comprising a set of single-domain discrete components made from a nanocrystalline iron-cobalt alloy with a thickness of 20 nm arranged on said nonmagnetic layer. The coercive intensity value of the code elements varied from 75 to 200 Oe.

The discrete components had a minimum size varying from 1 to 10 μm, a maximum size of 6 to 60 μm, and shape anisotropy of 1 to 6. Thus, for example, the discrete components with a width of 1 μm had a length of up to 6 μM.

The identification mark was placed inside a polyethylene sheath with a portion of fabric which in turn was placed in a plurality of alternate magnetic fields generated by three sources of external magnetic field with mutually orthogonal magnetic field directions. The distance from the identification mark to said magnetic field sources was up to 15 cm. The alternate magnetic field with simultaneously varying frequency and amplitude was used to act on the mark. The frequency varied from 50 to 218 Hz, and the amplitude varied from 50 to 210 Oe. Signals with the amplitude sufficient for a reliable operation of an analog-to-digital converter were recorded by a recording device situated at up to 15 cm from the identification mark.

### EXAMPLE 4

An identification mark comprising a lavsan substrate with a thickness of 30 μm and an area of 4 cm was produced. A low-coercivity layer made from nanocrystalline cobalt with a thickness of 10 nm and an area of 4 cm² was applied to said substrate. A nonmagnetic layer made from aluminum oxide with a thickness of 15 nm was placed on top of said low-coercivity layer, with a layer comprising a set of single-domain discrete components made from nanocrystalline nickel with a thickness of 50 nm arranged on said nonmagnetic layer. The coercive intensity value of the code elements varied from 40 to 85 Oe.

The discrete components had a minimum size varying from 0.5 to 2 μm, a maximum size of 3 to 12 μm, and shape anisotropy of 1 to 12. Thus, for example, the discrete components with a width of 0.5 μm had a length of up to 6 μm.

The identification mark was placed on a metal plate (a can lid). The distance from the identification mark to said magnetic field sources was up to 10 cm. The alternate magnetic field was used to act on the mark. The magnetic field amplitude varied from 50 to 250 Oe.

Signals with the amplitude sufficient for a reliable operation of an analog-to-digital converter were recorded by a recording device situated at up to 10 cm from the identification mark.

### EXAMPLE 5

An identification mark comprising a substrate made from a special paper with a thickness of 100 μm and an area of 5 cm was produced. A low-coercivity layer made from nanocrystalline cobalt with a thickness of 60 nm and an area of 3 cm was applied to said substrate. A nonmagnetic layer made from silicon oxide with a thickness of 10 nm was placed on top of said low-coercivity layer, with a layer comprising a set of single-domain discrete components made from nanocrystalline iron with a thickness of 25 nm arranged on said nonmagnetic layer. The coercive intensity value of the code elements varied from 60 to 160 Oe.

The discrete components had a minimum size varying from 0.3 to 5 μm, a maximum size of 3 to 30 μm, and shape anisotropy of 1 to 6. Thus, for example, the discrete components with a width of 5 μm had a length of up to 30 μm.

The identification mark was placed on the surface of an ampoule with water. The distance from the identification mark to said magnetic field sources was up to 7 cm. The alternate magnetic field with the frequency of 50 Hz and amplitude of 170 Oe was used to act on the mark.

Signals with the amplitude sufficient for a reliable operation of an analog-to-digital converter were recorded by a recording device situated at up to 7 cm from the identification mark.

### EXAMPLE 6

An identification mark was produced substantially as described in Example 5 with the difference that the minimum size of the discrete components varied from 5 to 10 μm, the maximum size varied from 30 to 60 μm, and shape anisotropy was of 1 to 6. Thus, for example, the discrete components with a width of 5 μm had a length of up to 30 μm.

The identification mark was placed inside a polyethylene bag, and the distance from the identification mark to said magnetic field sources was up to 8 cm. the alternate low-frequency magnetic field with the frequency of 50 Hz and amplitude of 170 Oe was used to act on the mark.

Signals with the amplitude sufficient for a reliable operation of an analog-to-digital converter were recorded by a recording device situated at up to 8 cm from the identification mark.

1. An identification mark comprising:
a plurality of code elements, each having a different coercive intensity in the external magnetic field of a given direction and adapted to emit an electromagnetic pulse when the amplitude of said external magnetic field of said given direction acting upon each code element to reverse magnetization thereof levels the coercive intensity value of each code element;
a substrate having said plurality of code elements arranged thereon;
said each code element of said plurality of code elements including:
a low-coercivity layer with a coercive intensity;
at least a first group of discrete components with a coercive intensity value exceeding the coercive intensity value of said low-coercivity layer,
said each discrete components of said first group of discrete components are made single-domain from a magnetic material when magnetized in the easy direction and magnetically connected to said low-coercivity layer;
said each discrete components of said first group of discrete components having the same size, shape anisotropy, coercive intensity, amount of magnetic material and arranged at the same distance to the neighboring discrete component;
a nonmagnetic layer arranged between said low-coercivity layer and said first group of discrete components.

2. The identification mark as claimed in claim 1, wherein said low-coercivity layer is provided on said substrate in said each code element.

3. The identification mark as claimed in claim 1, wherein said first group of discrete components is provided on said substrate in said each code element.

4. The identification mark as claimed in claim 1, comprising:
said each discrete component made from the same source magnetic material;
said each discrete component from said first group of discrete components of said each code element having the size, shape anisotropy, coercive intensity and amount of magnetic material other than the size, shape anisotropy, coercive intensity and amount of magnetic material of said each discrete component from said first group of discrete components of any other said code element.

5. The identification mark as claimed in claim 4, wherein said each discrete component from said first group of discrete components of said each code element is arranged at the same distance to the neighboring said discrete component as the distance at which said each discrete component from said first group of discrete components of any other said code element is arranged from the neighboring said discrete component.

6. The identification mark as claimed in claim 4, wherein said each discrete component from said first group of discrete components of said each code element is arranged at a distance to the neighboring said discrete component other than the distance at which said each discrete component from said first group of discrete components of any other said code element is arranged from the neighboring said discrete component.

7. The identification mark as claimed in claim 1, wherein said low-coercivity layer of said each code element is made integrally with said low-coercivity layer of any other said code element.

8. The identification mark as claimed in claim 1, wherein said nonmagnetic layer of said each code element is made integrally with said nonmagnetic layer of any other said code element.

9. The identification mark as claimed in claim 1, wherein said each code element comprises a second group of discrete components, each discrete component from said second group having the size, shape anisotropy, coercive intensity, amount of magnetic material and the distance to the neighboring said discrete component similar to the size, shape anisotropy, coercive intensity, amount of magnetic material and the distance to the neighboring said discrete component of said each discrete component from said first group, said each discrete component from said first and said second groups being arranged such that said easy direction of said each discrete component in each said group is parallel to said easy direction of said each neighboring discrete component and forms an angle of 45 to 90 degrees relative to said easy direction of said each discrete component of the other said group.

10. The identification mark as claimed in claim 1, wherein said first group of discrete components of each said code element has a total area whose ratio to the area of said low-coercivity layer of said code element is of from 0.001 to 0.9.

11. The identification mark as claimed in claim 1, comprising a reference code element whose area exceeds the area of said each code element of said plurality of code elements.

12. The identification mark as claimed in claim 1, wherein said low-coercivity layer of said each code element has a thickness of 10 to 500 nm.

13. The identification mark as claimed in claim 1, wherein said each discrete components from said first group has thickness of 0.1 to 5.0 of the thickness of said low-coercivity layer of said code element.

14. A method of reading out information from an identification mark, said method including the steps of:
creating an identification mark comprising:
a plurality of code elements, each having a different coercive intensity in the external magnetic field of a given direction
a substrate having said plurality of code elements arranged thereon;
said each code element of said plurality of code elements including:
said each code element of said plurality of code elements, comprising:
a low-coercivity layer with a coercive intensity;
at least a first group of discrete components with a coercive intensity value exceeding said coercive intensity value of said low-coercivity layer;
said each discrete components of said first group of discrete components made single-domain from a magnetic material when magnetized in the easy direction and magnetically connected to said low-coercivity layer;
said each discrete components of said first group of discrete components having the same size, shape anisotropy, coercive intensity, amount of magnetic material and arranged at the same distance to the neighboring said discrete component;
a nonmagnetic layer arranged between said low-coercivity layer and said first group of discrete components;
creating a plurality of alternate external magnetic fields of a given direction, each alternate external magnetic fields of a given direction of said plurality of alternate external magnetic fields having a having a different rate of change with time;
sequential magnetization reversal of said plurality of code elements using said plurality of external alternate magnetic fields of a given direction;
recording of each magnetic pulse emitted by each said code element when the amplitude of each external alternate magnetic field of a given direction acting upon each code element to reverse magnetization thereof levels said coercive intensity value of said each code element;
processing said each electromagnetic pulse and obtaining the information carried by each said code element.

15. The method as claimed in claim 14, wherein said each code element comprises a second group of discrete components, each discrete component from said second group having the size, shape anisotropy, coercive intensity, amount of magnetic material and the distance to the neighboring said discrete component similar to the size, shape anisotropy, coercive intensity, amount of magnetic material and the distance to the neighboring said discrete component of said each discrete component from said first group, said each discrete component from said first and said second groups being arranged such that said easy direction of said each discrete component in each said group is parallel to said easy direction of said each neighboring discrete component and forms an angle of 45 to 90 degrees relative to said easy direction of said each discrete component of the other said group.

16. The method as claimed in claim 14, wherein to establish said plurality of alternate external magnetic fields of a given direction three sources are used, whereby three said alternate external magnetic fields of a given direction are established, the vectors of each said field being mutually orthogonal to each other, said three sources being sequentially arranged along the direction in which the identification mark is moved upon magnetization reversal thereof.

17. The method as claimed in claim 15, wherein to establish said plurality of external alternate magnetic fields of a given direction three pairs of source are used, whereby three pairs of said external alternate magnetic fields of a given direction are established, the vectors of each said pair being mutually orthogonal to each other, the vectors in each said pair are arranged at an angle of 45 to 90°, and said three sources being sequentially arranged along the direction in which the identification mark is moved upon magnetization reversal thereof.
